(19) United States
(12) Patent Application Publication
(10) Pub. No.: US 2013/0134802 A1
(43) Pub. Date: May 30, 2013

(54) APPARATUS AND METHOD FOR USE IN TRANSFERRING AN ELECTRICAL POWER SUPPLY IN ORDER TO BYPASS A TRANSFORMER BASED VOLTAGE OPTIMIZATION DEVICE

(71) Applicant: David Taylor, Rotherham (GB)

(72) Inventor: David Taylor, Rotherham (GB)

(73) Assignee: EMSC (UK) LIMITED, Rotherham (GB)

(21) Appl. No.: 13/816,375

(22) PCT Filed: Aug. 23, 2011
(86) PCT No.: PCT/GB11/01266

§ 371 Date: Feb. 11, 2013

(30) Foreign Application Priority Data
Aug. 27, 2010 (GB) 1014287.5

(51) Int. Cl. H02J 3/18; H02P 13/06

(52) U.S. Cl. CPC H02J 3/1878; H02P 13/06
USPC 307/130; 336/150

(57) ABSTRACT

A transformer based voltage-optimization device configured for use as a component of an electrical circuit that is associated with an electrical power supply, a load and a bypass switch connection, the voltage optimization device comprising a transformer comprising a control winding, an electrical power input means and a transformer tap, the voltage optimization device characterized by further comprising a control means configured to control the voltage potential across said transformer wherein the control means is configured to substantially equalize the voltage and the associated phase angle of the voltage across the transformer in order to limit the voltage potential across the control winding before disconnecting the transformer from the power supply.

### FIELD OF THE INVENTION

The present invention relates to a transformer apparatus. Particularly, although not exclusively, the invention relates to a voltage optimization device apparatus and methods for use in transferring an electrical power supply to bypass a transformer based voltage optimization device, without loss of power supply to various electrically powered devices associated with a given installation, such as a building, that is associated with the transformer based voltage optimization device.

### BACKGROUND TO THE INVENTION

It is known to install in domestic and industrial premises of one kind or another one or more transformer based voltage optimization devices in order to improve efficiency in terms of the amount of electrical power consumed from a given power supply such as a mains power supply. Typically such a power supply will comprise supply of an alternating current (a.c.).

The terminology “transformer based voltage optimization device” as used herein is to be interpreted as any device comprising a transformer that transforms a first alternating voltage to a second alternating voltage. The first alternating voltage may be lower than the second alternating voltage in which case the resultant voltage is thereby increased and said to be “stepped up”. Similarly the first alternating voltage may be higher than the second alternating voltage in which case the resultant voltage is thereby decreased and said to be “stepped down”. Furthermore, as those skilled in the art will understand, different terminology may be used in different countries as to what is meant by a “transformer based voltage optimization device”. Thus, for example, in Japan the equivalent terminology is that of “voltage power optimization device”. In the United States of America the terms “voltage reduction technology”, “voltage reduction device”, “voltage optimization technology” and “voltage optimization device” are all used and essentially relate to the same subject matter of a “transformer based voltage optimization device” as defined above.

A transformer based voltage optimization device may be installed in a wide variety of situations wherein a power supply is required to provide power to a load of one sort or another. Thus, for example, a main power supply is typically used to provide power to physical structures including, for example, permanent (fixed) buildings, temporary buildings and a variety of other inspirations requiring an electrical power supply in order to enable such installations to perform their function. Typically voltage optimization equipment comprising a device of the type referred to above comprises one or a plurality of transformers for stepping up and/or for stepping down (as required) the voltage in relation to particular load application(s) that is or are present in or otherwise associated with a given installation.

Those skilled in the art will understand that there are frequent and significant problems when it comes to maintenance of and/or repair of a voltage optimization device that is associated with a given installation. Thus those skilled in the art will appreciate that when a given voltage optimization device is required to undergo maintenance and/or repair a major problem arises in that electrical power to the installation as a whole is normally required to be shut down beforehand. This practice is clearly undesirable and manifests itself to the occupant and/or persons associated with the installation at the time as a temporary loss of power. For both domestic and industrial installations this can clearly represent a major inconvenience. For industrial premises this may lead to a loss of profit and/or otherwise affect a given business adversely.

Various approaches to solving the aforementioned technical problem have been tried and each is known to be associated with undesirable factors and/or outcomes. The standard approach is simply to switch off the electrical power to the installation housing the particular transformer based voltage optimization device that requires maintenance and/or repair. However, as discussed above, this frequently results in significant inconvenience.

Another approach is to attempt to transfer the electrical power supply to bypass a particular transformer based voltage optimization device by, for example, making use of a make before break bypass switch. However, as those skilled in the art will know, the latter approach is associated with its own problems, not least in that such an approach is highly liable to result in over heating of cables and/or windings and potential fire, or alternatively in loss of supplies due to circuit protection actuating.

In view of the above-referenced problems there is thus a need to provide an apparatus and method for use in transferring an electrical power supply in order to bypass a transformer based voltage optimization device without loss of power to various electrically powered devices associated with a given installation that is associated with a transformer based voltage optimization device.

Thus, there is a need to provide a solution to the aforementioned problems such that where a transformer based voltage optimization device is being maintained and/or repaired there is provided a seamless transfer of power supply to electrically powered equipment located in or otherwise associated with a given installation in respect of which the transformer based voltage optimization device is associated.

### SUMMARY OF THE INVENTION

An object of the present invention is to provide an apparatus and a method for transferring an electrical power supply to bypass a transformer based voltage optimization device without causing a loss of power supply to various electrically powered devices associated with a given installation that is associated with the transformer based voltage optimization device.

Another object of the present invention is to provide a voltage optimization device that is configured for safe use with a make before break bypass switch connection.

Another object of the present invention is to enable such a transfer of an electrical power supply to take place with no interruption in power as supplied to various electrically powered devices that are associated with the transformer based voltage optimization device.

Another object of the present invention is to provide a transformer based voltage optimization device that is configured with means to substantially equalize the voltage and the associated phase angle of the voltage across the transformer in order to limit the voltage potential across the control winding of the transformer before disconnecting the transformer from an associated power supply.

According to a first aspect of the present invention there is provided a transformer based voltage optimisation device configured for use as a component of an electrical circuit that is associated with an electrical power supply, a load and a bypass switch connection, said voltage optimization device comprising:

a transformer comprising a control winding, an electrical power input means and a transformer tap;

said voltage optimization device characterized by further comprising:

a control means configured to control the voltage across said transformer, wherein:

said control means is configured to substantially equalize the voltage and the associated phase angle of the voltage across said transformer in order to limit the voltage potential across said control winding before disconnecting said transformer from said power supply.

Preferably said device is of the type configured to step down said supplied voltage.

Preferably said device is of the type configured to step up said supplied voltage.

Preferably said device is configured to be powered by a three-phase power supply.

Preferably said control means comprises a plurality of switches.

Preferably said control means comprises one or more mechanically operated switches.

Preferably said control means comprises one or more electrically operated switches.

Preferably said control means comprises one or more electronically operated switches.

Preferably said device is of a type that optimises the output voltage in accordance with a predefined fixed amount, in Volts, according to the configuration of said voltage optimization device.

Preferably said predefined fixed amount is determined in accordance with the ratio of the output voltage to supply voltage.

Preferably said control means configured to control the voltage across said transformer comprises:

a first switch device configured to disconnect the power supply to said transformer tap thereby disconnecting a control voltage used to control said voltage across said transformer; and

a second switch device; wherein:

upon opening said first switch device of said control means said power supply to said tap is thereby disconnected and thereafter said second switch device is substantially automatically configured to close in order to thereby provide a substantially equalized voltage and a substantially equalized phase angle of said voltage across said transformer.

Preferably said control means configured to control the voltage potential across said transformer is configured to operate in accordance with predefined settings of said associated bypass switch in order to ensure the above specified sequence of switching is adhered to.

Preferably said control means configured to control the voltage potential across said transformer is mechanically operated by way of a safety key interlock of said associated bypass switch in order to ensure the above specified sequence of switching is adhered to.

Preferably removal of said safety key interlock rotates a shaft connected to said first switch device in order to open said first switch device and thereby disconnect said power supply to said tap.

Preferably when said transformer has been disconnected from said power supply, but is required to be reconnected, said sequence of switching is substantially reversed

so that when said second switch device is open said first switch device is then automatically closed in order to reapply the voltage potential to said transformer tap.

Preferably said device is of a type that optimises the output voltage in accordance with a variable amount of adjustment in order to maintain a substantially constant output voltage.

Preferably said control means configured to control the voltage potential across said transformer comprises:

a variable voltage control circuit configured for use in controlling said transformer.

Preferably said device additionally comprises:

a variable voltage control circuit configured for use in controlling a control voltage of said transformer; and

said control means configured to control the voltage potential across said transformer comprises:

a first switch device configured to disconnect the power supply to said variable voltage control circuit;

a second switch device; and

a third switch device configured to disconnect the power supply to said transformer tap;

wherein upon opening said first switch device of said control means said power supply to said variable voltage control circuit is thereby disconnected and thereafter said second switch device is substantially automatically configured to close in order to connect said transformer tap to neutral and thereafter said third switch device is substantially automatically configured to open in order to thereby provide a substantially equalized voltage and a substantially equalized phase angle of said voltage across said transformer.

Preferably said control means configured to control the voltage potential across said transformer is configured to operate in accordance with predefined settings of said associated bypass switch in order to ensure the above specified sequence of switching is adhered to.

Preferably said control means configured to control the voltage potential across said transformer is mechanically operated by way of a safety key interlock of said associated bypass switch in order to ensure the above specified sequence of switching is adhered to.

Preferably said above specified sequence of switching is initiated by removal of said safety key that rotates a shaft connected to said first switch in order to open said first switch and thereby disconnect said power supply to said variable voltage control circuit.

Preferably when said transformer has been disconnected from said power supply, but is required to be reconnected, said claimed sequence of switching is substantially reversed in accordance with the following steps:

said third switch device is substantially automatically closed in order to reapply the voltage potential to the transformer based voltage optimization device;

after a short delay second switch device is opened; and

upon determining that second switch device is open first switch device is closed.

According to a second aspect of the present invention there is provided, a method of transferring an electrical power supply in order to bypass a transformer based voltage optimization device whilst maintaining the electrical power supply to a load, said transformer based voltage optimization device comprising a transformer having a control winding, an electrical power input means and a transformer tap, wherein said voltage optimization device is configured for use as a component of an electrical circuit that is associated with an electrical power supply, the load and a bypass switch connection, a method of transferring said electrical power supply in order to bypass said voltage optimization device whilst maintaining the supply of power to said load, said method characterised by comprising the steps of:

controlling the voltage potential across said transformer in order to substantially equalize the voltage and the associated phase angle of the voltage across said transformer and thereby to limit the voltage across said control winding; and

disconnecting said transformer from said power supply after completion of the step of controlling, the disconnecting being effected by the bypass switch such that said transformer is bypassed without loss of power to the load.

Preferably said device is of the type configured to step down said supplied voltage.

Preferably said device is of the type configured to step up said supplied voltage.

Preferably said device is configured to be powered by a three-phase power supply.

Preferably said step of controlling said voltage potential comprises a substantially predefined switching procedure.

Preferably said switching procedure is effected by way of one or more mechanically operated switches.

Preferably said switching procedure is effected by way of one or more electrically operated switches.

Preferably said switching procedure is effected by way of one or more electronically operated switches.

Preferably said device is of a type that optimises the output voltage in accordance with a predefined fixed amount, in Volts, according to the configuration of said voltage optimization device.

Preferably said predefined amount is determined in accordance with the ratio of the output voltage to the supply voltage.

Preferably said step of controlling the voltage across said transformer comprises:

providing a first switch device and a second switch device;

opening said first switch device thereby disconnecting the power supply to said transformer tap and thereby disconnecting a control voltage used to control said voltage across said transformer;

opening said first switch device in order to disconnect the power supply to said tap; and

closing said second switch device in order to thereby provide said substantially equalized voltage and a substantially equalized phase angle of said voltage across said transformer, the closing said second switch device being performed after opening said first switch device.

Preferably said step of controlling the voltage potential across said transformer is performed in accordance with predefined settings of a bypass switch in order to ensure the claimed sequence of switching is adhered to.

Preferably said step of controlling the voltage potential across said transformer is performed mechanically by way of a safety key interlock of an associated bypass switch in order to ensure the claimed sequence of switching is adhered to.

Preferably said above specified sequence of switching is initiated by removal of said safety key that rotates a shaft connected to said first switch in order to open said first switch and thereby disconnect said power supply to said tap.

Preferably when said transformer has been disconnected from said power supply, but is required to be reconnected, said claimed sequence of switching is substantially reversed in accordance with the following steps:

when said second switch device is proven to be open said first switch device is then automatically closed in order to reapply the voltage potential to said transformer tap.

Preferably said device is of a type that optimises the output voltage in accordance with a variable amount of adjustment in order to maintain a substantially constant output voltage.

Preferably said step of controlling the voltage across said transformer comprises:

providing a variable voltage control circuit configured for use in controlling said transformer.

Preferably said step of controlling the voltage across said transformer comprises:

providing a variable voltage control circuit configured for use in controlling the control voltage of said transformer;

providing a first switch device, a second switch device and a third switch device, said first switch device configured to disconnect the power supply to said variable voltage control circuit and said third switch device configured to disconnect the power supply to said transformer tap;

opening said first switch in order to disconnect the power supply to said variable voltage control circuit;

closing said second switch device in order to connect said transformer tap to neutral, the closing said second switch device being performed after opening said first switch; and

opening said third switch in order to thereby provide said substantially equalized voltage and said substantially equalized phase angle of said voltage across said transformer, the opening said third switch being performed after closing said second switch.

Preferably said step of controlling the voltage across said transformer is performed in accordance with predefined settings of said associated bypass switch in order to ensure the above specified sequence of switching is adhered to.

Preferably said step of controlling the voltage across said transformer is performed mechanically by way of a safety key interlock of said associated bypass switch in order to ensure the above specified sequence of switching is adhered to.

Preferably said step of opening said first switch is initiated by removal of a safety key that rotates a shaft connected to said first switch in order to open said first switch and thereby disconnect said power supply to said variable voltage control circuit.

Preferably when said transformer has been disconnected from said power supply, but is required to be reconnected, the method performs the following steps:

Closing said third switch device in order to reapply the voltage to said transformer based voltage optimization device;

Opening said second switch device-; and

Closing said first switch device-after said second switch device is opened.

According to a third aspect of the present invention there is provided a kit of parts comprising:

a transformer based voltage optimization device as claimed in claim 1; and

the bypass switch, according to the first aspect of the present invention, configured to control the operation of said transformer based voltage optimization device.

Preferably said bypass switch is operable according to at least first and second modes of operation as follows:

in said first mode of operation said bypass switch initiates said equalisation of said voltage and said equalisation of said phase angle of said voltage across said transformer in order to then allow said power supply to be disconnected from said transformer and to connect said power supply to said load; and

in said second mode of operation, starting from said first mode of operation, said bypass switch initiates disconnection of said power supply to said load and connection of said power supply to said transformer.

Preferably said bypass switch comprises first, second and third isolating switches located on a common shaft such that:

said first switch is connectable to said power supply in order to respectively, as required, transmit received power to and to prevent power being received by said voltage optimization device;

said second switch is connectable to either an output of said voltage optimization device or to said load, said second switch configured to disconnect said output from said voltage optimization device; and

said third switch is connectable to said power supply so as to transmit electrical power to said load when said first and second switches are both open circuit.

According to a fourth aspect of the present invention there is provided a transformer based voltage optimization device configured for use as a component of an electrical circuit that is associated with an electrical power supply, a load and a bypass switch connection, said voltage optimization device comprising:

a transformer comprising a control winding, an electrical power input means and a transformer tap;

said voltage optimization device characterized by further comprising:

a control means configured to control the voltage potential across said transformer; said control means configured to substantially equalize the voltage and the associated phase angle of the voltage across said transformer in order to limit the voltage potential across said control winding before disconnecting said transformer from said power supply, said control means comprising:

a first switch device configured to disconnect the power supply to said transformer tap thereby disconnecting the control voltage as is used to control said voltage potential across said transformer; and

a second switch device; wherein:

upon opening said first switch of said control means said power supply to said tap is thereby disconnected and thereafter said second switch is substantially automatically configured to close in order to thereby provide said substantially equalized voltage and said substantially equalized phase angle of said voltage across said transformer.

According to a fifth aspect of the present invention there is provided a transformer based voltage optimization device configured for use as a component of an electrical circuit that is associated with an electrical power supply, a load and a bypass switch connection, said voltage optimization device comprising:

a transformer comprising a control winding, an electrical power input means and a transformer tap;

said voltage optimization device characterized by further comprising:

a variable voltage control circuit configured for use in controlling the control voltage of said transformer; and

a control means configured to control the voltage potential across said transformer, said control means configured to substantially equalize the voltage and the associated phase angle of the voltage across said transformer in order to limit the voltage potential across said control winding before disconnecting said transformer from said power supply, said control means comprising:

a first switch device configured to disconnect the power supply to said variable voltage control circuit;

a second switch device; and

a third switch device configured to disconnect the power supply to said transformer tap;

wherein upon opening said first switch of said control means said power supply to said variable voltage control circuit is thereby disconnected and thereafter said second switch device is substantially automatically configured to close in order to connect said transformer tap to neutral and thereafter said third switch device is substantially automatically configured to open in order to thereby provide said substantially equalized voltage and said substantially equalized phase angle of said voltage across said transformer.

According to a sixth aspect of the present invention there is provided a transformer based voltage optimization device configured for use as a component of an electrical circuit that is associated with a load, said voltage optimization device comprising:

first determination means configured to determine, in accordance with a predefined range of tolerance, if there is a difference in voltage as between the supply voltage to said voltage optimization device and the output voltage therefrom;

second determination means configured to determine, in accordance with a predefined range of tolerance, if there is a difference in phase angle as between said supply voltage and said output voltage;

voltage adjustment means that is responsive to a determination that there is a difference between said supply voltage and said output voltage, said voltage adjustment means thereby configured to adjust said output voltage of said device so that it is substantially equal to said input voltage;

voltage phase angle adjustment means that is responsive to a determination that there is a difference between said phase angle of said supply voltage and said phase angle of said output voltage and said voltage phase angle adjustment means configured to adjust said phase angle of said output voltage of said device so that it is substantially equal to the phase angle of said input voltage; and

control signal generation means configured such that upon said respective input and said output voltages being substantially equal and upon said respective phase angles of said input and said output voltages being substantially equal, a control signal is generated that is configured to control the operation of a switch arrangement associated with said voltage optimization device, said switch arrangement configured to disconnect the output of said transformer based voltage optimization device from said circuit and to connect said power supply directly to said load.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 schematically illustrates, in the form of a circuit diagram, a transformer based voltage optimization device 101 as is configured in accordance with the present invention to operate in conjunction with a known make before break bypass switch connection 105;

FIG. 2 schematically illustrates, in the form of a circuit diagram, a first preferred embodiment 201 of a voltage transformer based voltage optimization device 101, as configured in accordance with the present invention, for use in conjunction with the switch connection of FIG. 1;

FIG. 3 schematically illustrates, in the form of a circuit diagram, a second preferred embodiment 301 of a voltage transformer based voltage optimization device 101, as configured in accordance with the present invention, for use in conjunction with the switch connection of FIG. 1; and

FIG. 4 schematically illustrates a circuit diagram of a third preferred embodiment voltage transformer based voltage optimization device for use in conjunction with the switch connection of FIG. 1.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

As identified above use of ‘Make before Break Bypass switches’ with transformer based voltage optimization devices (transformers/voltage optimization units/voltage reduction devices and the like), will create high circulating currents which can result in overheating of cables/windings and potential fires, or alternatively loss of supplies due to circuit protection actuating.

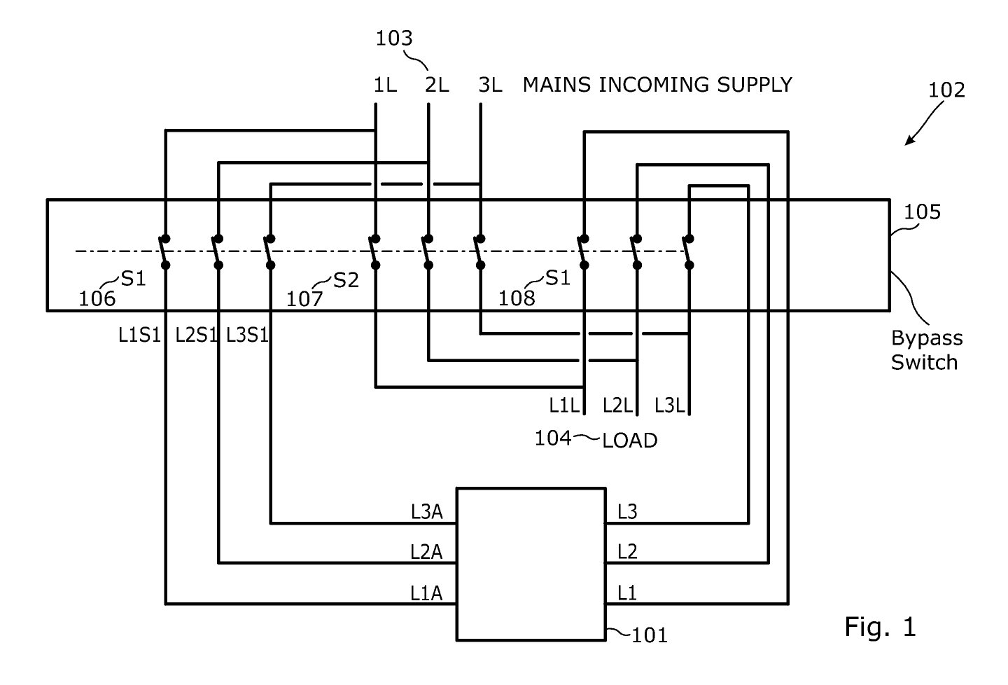

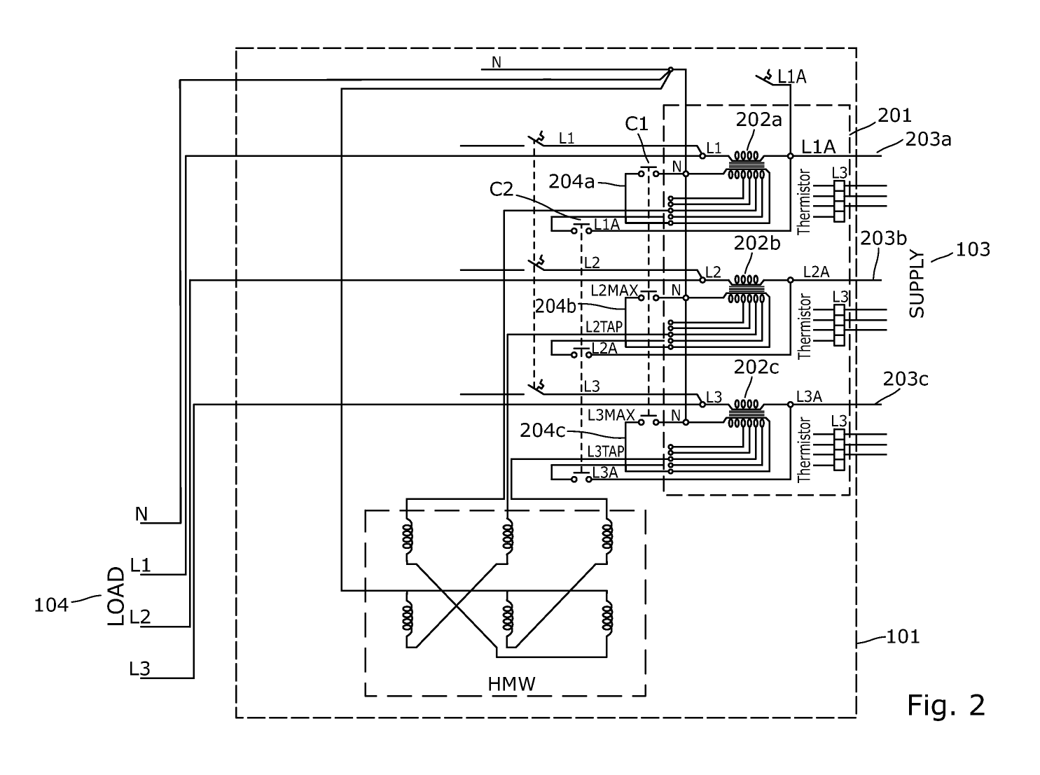

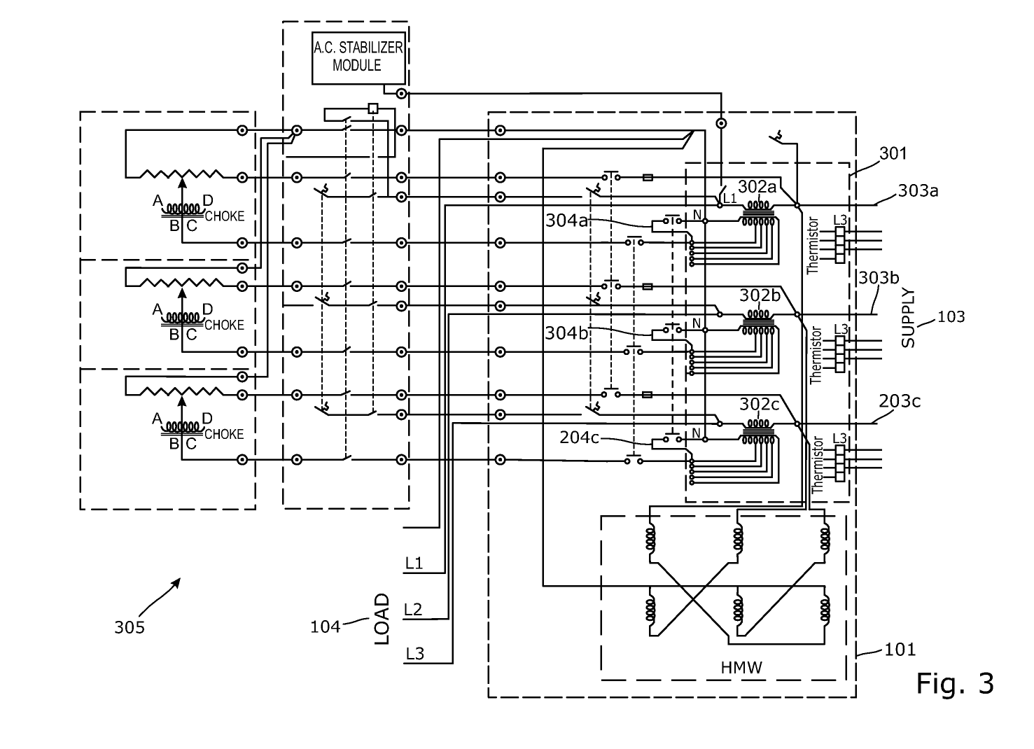

In accordance with the present invention this problem is solved by use of a transformer based voltage optimization device that is specially configured for use with a known make before break bypass connection. FIG. 1 schematically illustrates a typical arrangement of a known make before break bypass switch connection as is suitable for use in conjunction with a transformer based voltage optimization device as configured in accordance with the present invention. The example shown relates to three-phase electric power which as will be understood by those skilled in the art is the most common method of alternating-current (a.c.) electric power transmission used across the world. However the present invention is not to be considered as limited to three-phase power. Rather the general principles disclosed herein are also applicable to single phase and poly phase electrical power distribution systems. Thus the exemplary prior art bypass switch connection of FIG. 1 and, in accordance with the present invention, the transformer based voltage optimization devices of FIGS. 2 and 3 as presented herein, are merely provided by way of example as the general principles disclosed are applicable to other (non three-phase) methods of a.c. power transmission.

In order to maintain voltage optimization equipment, whilst providing a seamless transfer of supplies, the inventors of the present invention have determined that it is necessary to match the output alternating voltage and phase angle to that of the supply prior to undertaking any switching. In this way the present invention provides a means of transferring the supply to bypass the transformer based voltage optimization device without loss of supply by disabling the control winding of the transformer prior to paralleling the main supply feeding the load and the transformer based voltage optimization device. In the best mode contemplated the input voltage is matched to the output voltage as closely as possible although as those skilled in the art will understand a lesser degree of voltage matching will also yield beneficial results, but to a lesser extent than where the input voltage exactly matches the output voltage.

By way of example, known manufacturers of such bypass connections include Fortress Interlocks Limited and Castell Limited.

A transformer based voltage optimization device 101 as configured in accordance with the invention is schematically illustrated in FIG. 1. Device 101 is shown as connected in an electrical circuit 102 that is configured to receive an electrical power supply 103 such as a mains power supply. Transformer based device 101, when operating to transform a received voltage, is configured to optimise the received electrical power 103 for use in powering a load 104.

Connectably located between device 101 and mains supply 103 there is also provided a bypass switch connection 105 that, in normal operation, is configured to permit electrical power to be supplied directly to device 101. However, during periods of maintenance or repair of device 101, in accordance with the present invention, bypass switch 105 is configured to transfer electrical power directly to load 104 rather than via transformer based voltage optimization device 101. In accordance with the present invention the transfer of electrical power takes place such that the aforementioned problems associated with the prior art usage of a bypass switch with a transformer based device 101 are overcome.

Bypass switch 105 comprises of three separate isolators (switches) S1, S2 and S1 respectively labelled switches 106, 107 and 108. First and second ‘S1’ switches, respectively switches 106 and 108, are operationally coupled so that upon their being switched to an ‘ON’ state both these switches are ‘ON’ (i.e. ‘made’) and likewise when switched to an ‘OFF’ state both these switches are ‘OFF’ (i.e. ‘open’). In the best mode contemplated a bypass switch 105 as configured for use in relation to the present invention thus comprises three separate switches (S1, S2 and S3) wherein all three are located on a common shaft.

Bypass switch connection 105 as depicted in FIG. 1 is such that bypass switch 105 is shown in a first configuration or ‘Position 1’.

Position 1 (as depicted) is that concerned with the transition to bypassing transformer based voltage optimization device 101. In this case switches S1, that is switches 106 and 108, and switch S2, that is switch 106, are all made (i.e. on).

Position 2, (not depicted), is such that the settings of switches 106, 107 and 108 are configured in order to enable transformer based voltage optimization device 101 to perform the desired function of providing energy savings. In this configuration both switches S1, that is switches 106 and 108, are made and switch S2, (that is) 107, is open circuit.

Position 3 (not depicted) is that concerned with the mode of operation wherein transformer based voltage optimization device 101 is bypassed. In this case switch S2, that is switch 107, is made and switches S1,—that is switches 106 and 108, are open (i.e. that is they are open circuit).

In essence, in order to effect a transfer of the electrical power supply 103, bypass switch connection 101 shorts out the transformer of device 101 by connecting the input of the transformer of device 101 to the output of said transformer. This is where problems arise if a known make before bypass switch connection 105 is used with a prior art type transformer based voltage optimization device. Thus, in relation to a known transformer based voltage optimization device, if the voltage input is, for example, 240V and the voltage output is fixed at 10V higher then the output voltage will be 250V and circulating currents will arise. Likewise if there is a difference between the phase angle of the input voltage and that of the output voltage then again circulating currents will arise.

In accordance with the present invention, before prior art make before break bypass switch 105 may be used, a transformer based voltage optimization device, such as device 101 as is configured in accordance with the present invention, must be provided which overcomes the above-mentioned problem of the presence of highly undesirable circulating currents.

In order to solve the aforementioned problem the inventors if the present invention have discovered that the problem may be overcome by providing a transformer based voltage optimization device wherein the device is “balanced” as follows:
(i) the output voltage should match the input voltage; and
(ii) the phase angle of the output voltage should match the phase angle of the input voltage

This has been found to be necessary in order to avoid overloading the transformer and tripping the whole power supply 103 to the various electrically powered devices associated with load 104.

However, providing such a transformer that solves the aforementioned problem is less than straightforward. The inventors have devised various switching scenarios wherein the required balancing of the voltage input and voltage output and the required balancing of the phase angle of the output voltage with the phase angle of the input voltage may be achieved. Preferred embodiments of transformer based voltage optimization device 101 as configured in accordance with the present invention for use in conjunction with make before break bypass switch connection 105 are thus described below.

A first preferred embodiment of device 101, schematically illustrated in FIG. 2, relates to a ‘fixed voltage’ transformer based voltage optimization device 201. In such a configuration when the input voltage drops, the output voltage also drops and the drop in the output voltage is roughly proportional to the drop in the input voltage.

A second preferred embodiment of device 101, schematically illustrated in FIG. 3, relates to ‘variable voltage’ transformer based voltage optimization device 301 that may be referred to as a variable voltage ‘servo’ control unit. This represents the best mode of a transformer based voltage optimization device as contemplated by the inventors of the present invention because it is configured to provide an infinitely variable output voltage. In other words if the input voltage drops or increases voltage optimization device 301 is nevertheless configured to maintain a constant output voltage.

### (1) Fixed Voltage Transformer Based Voltage Optimization Device

FIG. 2 schematically illustrates, in the form of a circuit diagram, a preferred embodiment of a transformer based voltage optimization device 101 as configured in accordance with the present invention for use in conjunction with the switch connection 105 of FIG. 1.

In accordance with FIG. 2 a preferred embodiment of voltage optimization device 101 comprises a transformer 201 configured to receive a three phase power supply. Transformer 201 comprises respective control windings 202a, 202b and 202c each being coupled to respective conductors 203a, 203b and 203c. Each respective control winding 202a to 202c is associated with a respective transformer tap 204a, 204b and 204c. Transformer 201 is associated with a control means in the form of respective switches: switching device C1 located adjacent to the transformer tap and switching device C2 connected down current thereof. Switch C1 is configured to affect the power supply via respective transformer tap components 204a, 204b and 204c as is switching device C2. In this way the control means, comprising switches C1, C2, is configured to substantially enable the voltage and the associated phase angle of the voltage across the transformer 201 to be equalised in order to limit the voltage potential across the respective control windings (202 a-c) before disconnecting transformer 201 from power supply 103.

In relation to bypass switch connection 105 a safety key interlock (safety key') is employed to ensure the predetermined sequence of operation as follows is carried out without deviation.
The procedure is initiated by removal of the safety key. Removal of the key rotates a shaft connected to a switch which in turn causes the supply to the control voltage of device 101 to be removed by mechanical, electrical or electronic switching.

Referring to FIG. 2 the sequence of switching is as follows:
i. Immediately the key switch is operated the switching device shown as C2 opens disconnecting the power to the transformer tap.
ii. When C2 is proven to be open switching device C1 is then automatically closed to equalise the voltage across the transformer and limit the voltage potential across the control winding.
Insertion of the safety key into the bypass operating mechanism releases a bolt which frees the shaft to rotate.
From the initial switch position ‘I (savings)’ on the bypass switch, turning the switch to the second ‘I+II’ position puts the mains supply in parallel with the transformer based voltage optimization device and traps the safety key thus preventing reapplication of the control voltage.
Operation of the switch to the third position ‘II (bypass)’ removes the transformer based voltage optimization device from the circuit and connects the mains direct to the load. The Safety key remains trapped in the lock.

To switch the bypass back to the transformer based voltage optimization device mode is a reversal of the procedure. The steps, as per the sequence of switching, are as follows:
Operation of the switch to the second ‘I+II’ position puts the mains supply in parallel with the transformer based voltage optimization device and retains the key trapped in the lock thus preventing reapplication of the control voltage.
Operation of the switch to the first ‘I (savings)’ position connects the transformer based voltage optimization device to the load and removes the mains direct to the load.
The safety key is now free to rotate in the bypass operating mechanism releasing a bolt which locks the shaft to prevent rotation.
The procedure is ended by returning the safety key. Turning the key rotates a shaft connected to a switch which in turn causes the supply to the control voltage to be restored by mechanical, electrical or electronic switching. Referring to FIG. 2 the sequence of switching is as follows:
i. When C1 is proven to be open switching device C2 is then automatically closed to reapply the voltage potential to the transformer tap.
ii. Immediately the key switch is operated it is trapped in position.

### (2) Variable Voltage Transformer Based Voltage Optimization Device

FIG. 3 schematically illustrates, in the form of a circuit diagram, the best mode contemplated of a voltage transformer based voltage optimization device 101 as configured in accordance with the present invention for use in conjunction with the switch connection 105 of FIG. 1. In the best mode contemplated device 101 comprises a variable voltage transformer based voltage optimization arrangement.

In accordance with FIG. 3 transformer based voltage optimization device 101 comprises a transformer 301 that is substantially similar to transformer 201 of FIG. 2. In the example illustrated transformer 301, shown as a three phase power transformer, thus comprises respective control windings 302a, 302b and 302c each respectively associated with a conductor associated with power supply 103. The three conductors are respectively 303a, 303b and 303c. Each respective control winding 302a to 302c is associated with a transformer tap respectively referenced as taps 304a, 304b and 304c. However, in contrast to the control means switching arrangement as described previously for the embodiment of FIG. 2, the control means associated with the transformer based optimization device of FIG. 3 differs in that here the switching mechanism comprises three switches (instead of two) which are associated with a variable voltage control circuit 305. Variable voltage control circuit 305 comprises three respective “choking” means wherein each respective “choking” means is configured to work in conjunction with the switching arrangement that is associated with each respective transformer tap 304a, 304b and 304c.

The variable voltage control circuit 305 is considered to be well known to those skilled in the art and therefore will not be described further.

However, the sequence of switching provided by the three aforementioned switches is now described. Associated with respective transformer taps 304a, 304b and 304c there is provided a switching device referenced C1 and down current thereof a further switching device referenced C2. Switching device C2 is electrically coupled to control circuit 305 and a further switching means referenced C2A is likewise electrically operable in relation to variable voltage control circuit 305.

In relation to bypass switch connection 105 a safety key interlock (safety key') is employed to ensure the predetermined sequence of operation as follows is carried out without deviation.
The procedure is initiated by removal of the safety key. Removal of the key rotates a shaft connected to a switch which in turn causes the supply to the control voltage to be removed by mechanical, electrical or electronic switching.

Referring to FIG. 3 the sequence of switching of switches C1, C2 and C2A is as follows:
i. Immediately the key switch is operated the switching device shown as C2A opens disconnecting the power to the voltage control circuit.
ii. When the switching device shown as C2A opens, the switching device shown as C1 is allowed to close connecting the transformer tap to neutral.
iii. Switching device C2 is then allowed to open and equalise the voltage across the transformer and limit the voltage potential across the control winding.
Insertion of the safety key into the bypass operating mechanism releases a bolt which frees the shaft to rotate.
From the initial switch position ‘I (savings)’ on the bypass switch, turning the switch to the second ‘I+II’ position puts the mains supply in parallel with the transformer based voltage optimization device and traps the Safety Key thus preventing reapplication of the control voltage.
Operation of the switch to the third position ‘II (bypass)’ removes the transformer based voltage optimization device from the circuit and connects the mains direct to the load. The Safety Key remains trapped in the lock.

To switch the bypass back to the transformer based voltage optimization device mode is a reversal of the procedure. The steps, as per the sequence of switching, are as follows:
Operation of the switch to the second ‘I+II’ position puts the mains supply in parallel with the transformer based voltage optimization device and retains the key trapped in the lock thus preventing reapplication of the control voltage.
Operation of the switch to the first ‘I (savings)’ position connects the transformer based voltage optimization device to the load and removes the mains direct to the load.
The safety key is now free to rotate in the bypass operating mechanism releasing a bolt which locks the shaft to prevent rotation.
The procedure is ended by returning the safety key. Turning the key rotates a shaft connected to a switch which in turn allows the supply to the control voltage to be restored when the ‘reset’ button is pressed by mechanical, electrical or electronic switching. Referring to FIG. 3 the sequence of switching is as follows:
i. Immediately the key switch is operated it is trapped in position.
ii. Switching device C2 is automatically closed to reapply the voltage potential to the voltage control device.
iii. Switching device C1 is opened after a short delay.
iv. When switching device C1 is proven open switching device C2A is allowed to close.

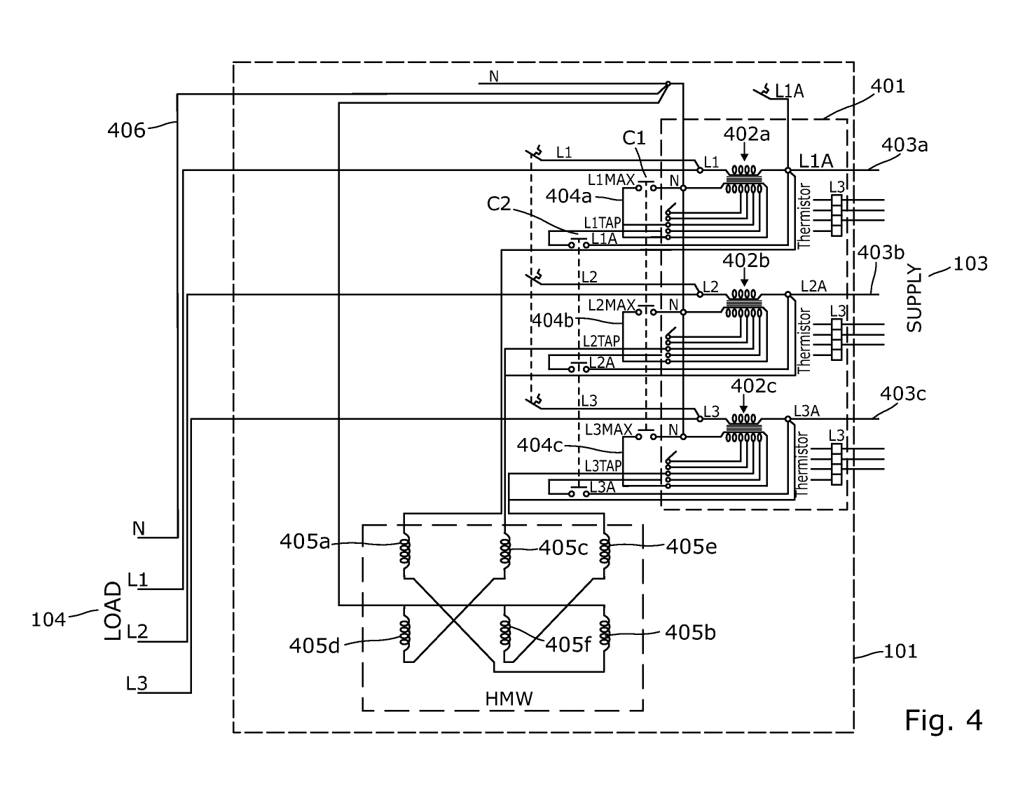

Referring to FIG. 4 herein, there is illustrated schematically a circuit diagram of a third voltage transformer based voltage optimization device, which can be used in conjunction with the switch connection of FIG. 1 herein.

The third voltage optimization device, comprises a transformer 401 receiving a three phase power supply. Transformer 401 comprises respective control windings 402a, 402b and 402c each being coupled to respective supply conductors 403a, 403b and 403c. Each respective control winding 402a to 402c is associated with a respective transformer tap 404a, 404b and 404c. Transformer 401 is associated with a control means in the form of respective switches: switching device C1 located adjacent to the transformer tap and switching device C2 connected down current thereof. Switch C1 is configured to affect the power supply via respective transformer tap components 404a, 404b and 404c as is switching device C2. In this way the control means, comprising switches C1, C2, is configured to substantially enable the voltage and the associated phase angle of the voltage across the transformer 401 to be equalised in order to limit the voltage potential across the respective control windings (402 a-c) before disconnecting transformer 401 from power supply 103.

In relation to bypass switch connection 105 a safety key interlock (‘safety key’) is employed to ensure that a predetermined sequence of operation as follows is carried out without deviation.
The procedure is initiated by removal of the safety key. Removal of the key rotates a shaft connected to a switch which in turn causes the supply to the control voltage of device 101 to be removed by mechanical, electrical or electronic switching.

Referring to FIG. 4 herein the sequence of switching is as follows:
i. Immediately the key switch is operated the switching device shown as C2 opens disconnecting the power to the transformer tap.
ii. When C2 is proven to be open switching device C1 is then automatically closed to equalise the voltage across the transformer and limit the voltage potential across the control winding.
   Insertion of the safety key into the bypass operating mechanism releases a bolt which frees the shaft to rotate.
   From the initial switch position ‘I (savings)’ on the bypass switch, turning the switch to the second ‘I+II’ position puts the mains supply in parallel with the transformer based voltage optimization device and traps the safety key thus preventing reapplication of the control voltage.
   Operation of the switch to the third position ‘II (bypass)’ removes the transformer based voltage optimization device from the circuit and connects the mains direct to the load. The safety key remains trapped in the lock.

To switch the bypass back to the transformer based voltage optimization device mode is a reversal of the procedure. The steps, as per the sequence of switching, are as follows:
Operation of the switch to the second ‘I+II’ position puts the mains supply in parallel with the transformer based voltage optimization device and retains the key trapped in the lock thus preventing reapplication of the control voltage.
Operation of the switch to the first ‘I (savings)’ position connects the transformer based voltage optimization device to the load and removes the mains direct to the load.
The safety key is now free to rotate in the bypass operating mechanism releasing a bolt which locks the shaft to prevent rotation.
The procedure is ended by returning the safety key. Turning the key rotates a shaft connected to a switch which in turn causes the supply to the control voltage to be restored by mechanical, electrical or electronic switching. Referring to FIG. 2 the sequence of switching is as follows:
iii. When C1 is proven to be open switching device C2 is then automatically closed to reapply the voltage potential to the transformer tap.
iv. Immediately the key switch is operated it is trapped in position.

The tap setting is selected according to the site of specific voltage measurements. For example, tap 3 as shown in FIG. 4 is only representative.

When the unit of FIG. 2 is placed in operation in the fixed mode, the harmonic mitigation windings were used as a means of creating a current path, but this was not optimal. Consequently, the circuit layout was amended to that shown in FIG. 4 herein. In FIG. 4, the operation of the switching itself is identical to that described herein before with reference to FIG. 2, as are the contacts.

For first control windings 402a, the fixed winding coils 405a, 405b of the harmonic mitigation windings are connected in a path between the supply conductor 403a and neutral load output 406.

Similarly, for the second control windings 402b, a second set of fixed windings 405c, 405d are connected between the supply conductor 403 to the second control windings 402b, and the neutral load output conductor 406.

Similarly, for the third control winding 402c, there are provided fixed load windings 405e, 405f connected between the supply conductor 403b feeding the third control winding 402c, and the neutral load conductor 406.

The harmonic mitigation windings 405a-405f absorb any harmonics in the circuit.

Whereas, in the device of FIG. 2 herein the windings of the harmonic mitigation windings are taken from a contactor, and then to the neutral of the load, in the third embodiment, the coils of the harmonic mitigation windings are positioned between the respective supply inputs to the transformer, and the neutral output.

In the first embodiment of FIG. 2 herein, since the coils of the harmonic mitigation windings are connected to the contacts on one side of the transformer, this means that switching occurred through the coils of the harmonic mitigation windings which led to voltage spikes.

However, in the third embodiment shown in FIG. 4 herein, as the coils of the harmonic mitigation windings are connected between the supply inputs, and the neutral output to the load, there is no switching through the harmonic mitigation windings and therefore no voltage spikes are passed through the harmonic mitigation windings Transient spikes are to be avoided wherever possible, since they reduce the reliability of components. The reliability of the contactors C2 are improved, by avoiding current or voltage spikes passing through them.

Otherwise, the contactors C1 and C2 operate in the first embodiment of FIG. 2 herein and the third embodiment of FIG. 4 herein similarly. Contactor C2 switches the supply on to the control winding of the transformer 402. First contact C1 switches the neutral onto the control windings of the transformers 202, 402. Depending which mode the device is working on, there is either a voltage across the control winding, or the control winding is a short circuit.

1-50. (canceled)

51. A transformer based voltage optimization device configured for use as a component of an electrical circuit that is associated with an electrical power supply, a load and a bypass switch connection, said voltage optimization device comprising:
a transformer comprising a control winding, an electrical power input means and a transformer tap;
said voltage optimization device characterized by further comprising:
a control means configured to control the voltage across said transformer, wherein:
said control means is configured to substantially equalize the voltage and the associated phase angle of the voltage across said transformer in order to limit the voltage across said control winding before said bypass switch disconnects said transformer from said power supply, such that said transformer is bypassed without loss of power to the load.

52. A transformer based voltage optimization device as claimed in claim 51, wherein said device is of the type configured to step down said supplied voltage.

53. A transformer based voltage optimization device as claimed in claim 52, wherein said control means comprises a plurality of switches.

54. A transformer based voltage optimization device as claimed in claim 51, wherein said device is of a type that optimises the output voltage in accordance with a predefined fixed amount, in Volts, according to the configuration of said voltage optimization device.

55. A transformer based voltage optimization device as claimed in claim 54, wherein said predefined fixed amount is determined in accordance with the ratio of the output voltage to supply voltage.

56. A transformer based voltage optimization device as claimed in claim 51, wherein said control means configured to control the voltage across said transformer comprises:
a first switch device configured to disconnect the power supply to said transformer tap thereby disconnecting a control voltage used to control said voltage across said transformer; and
a second switch device,
wherein upon opening said first switch device of said control means said power supply to said tap is thereby disconnected and thereafter said second switch device is substantially automatically configured to close in order to thereby provide a substantially equalized voltage and a substantially equalized phase angle of said voltage across said transformer.

57. A transformer based voltage optimization device as claimed in claim 54, wherein said control means configured to control the voltage across said transformer is mechanically operated by way of a safety key interlock of said associated bypass switch in order to ensure the claimed sequence of switching is adhered to.

58. A transformer based voltage optimization device as claimed in claim 55, wherein removal of said safety key interlock rotates a shaft connected to said first switch device in order to open said first switch device and thereby disconnect said power supply to said tap.

59. A transformer based voltage optimization device as claimed in claim 58, wherein when said transformer has been disconnected from said power supply, but is required to be reconnected, said sequence of switching is substantially reversed so that when said second switch device is open said first switch device is then automatically closed in order to reapply the voltage potential to said transformer tap.

60. A transformer based voltage optimization device as claimed in claim 56, wherein said device is of a type that optimises the output voltage in accordance with a variable amount of adjustment in order to maintain a substantially constant output voltage.

61. A transformer based voltage optimization device as claimed in claim 56, wherein said control means configured to control the voltage potential across said transformer comprises:
a variable voltage control circuit configured for use in controlling said transformer.

62. A transformer based voltage optimization device as claimed in claim 51, wherein said device additionally comprises:
a variable voltage control circuit configured for use in controlling a control voltage of said transformer; and
said control means configured to control the voltage potential across said transformer comprises:
a first switch device configured to disconnect the power supply to said variable voltage control circuit;
a second switch device; and
a third switch device configured to disconnect the power supply to said transformer tap;
wherein upon opening said first switch device of said control means said power supply to said variable voltage control circuit is thereby disconnected and thereafter said second switch device is substantially automatically configured to close in order to connect said transformer tap to neutral and thereafter said third switch device is substantially automatically configured to open in order to thereby provide a substantially equalized voltage and a substantially equalized phase angle of said voltage across said transformer.

63. A transformer based voltage optimization device as claimed in claim 62, wherein said control means configured to control the voltage potential across said transformer is configured to operate in accordance with predefined settings of said associated bypass switching order to ensure the claimed sequence of switching is adhered to.

64. A method of transferring an electrical power supply in order to bypass a transformer based voltage optimization device whilst maintaining the electrical power supply to a load, said transformer based voltage optimization device comprising a transformer having a control winding, and electrical power input means and a transformer tap, wherein said voltage optimization device is configured for use as a component of an electrical circuit that is associated with the electrical power supply, the load and a bypass switch connection, said method characterised by comprising the steps of:
controlling the voltage across said transformer in order to substantially equalize the voltage and the associated phase angle of the voltage across said transformer and thereby to limit the voltage across said control winding; and
disconnecting said transformer from said power supply after completion of the step of controlling, the disconnecting being effected by the bypass switch such that said transformer is bypassed without loss of power to the load.

65. The method as claimed in claim 64, wherein said step of controlling the voltage across said transformer comprises:
providing a first switch device and a second switch device;
opening said first switch device thereby disconnecting the power supply to said transformer tap and thereby disconnecting a control voltage used to control said voltage across said transformer;
opening said first switch device in order to disconnect the power supply to said tap; and
closing said second switch device in order to thereby provide said substantially equalized voltage and a substantially equalized phase angle of said voltage across said transformer, the closing said second switch device being performed after opening said first switch device.

66. The method as claimed in claim 64, wherein said step of controlling the voltage across said transformer comprises:
providing a variable voltage control circuit configured for use in controlling the control voltage of said transformer;
providing a first switch device, a second switch device and a third switch device, said first switch device configured to disconnect the power supply to said variable voltage control circuit and said third switch device configured to disconnect the power supply to said transformer tap;
opening said first switch in order to disconnect the power supply to said variable voltage control circuit;
closing said second switch device in order to connect said transformer tap to neutral, the closing said second switch device being performed after opening said first switch; and
opening said third switch in order to thereby provide said substantially equalized voltage and a substantially equalized phase angle of said voltage across said transformer, the opening said third switch being performed after closing said second switch.

67. The method as claimed in claim 64, wherein said step of controlling the voltage across said transformer is performed in accordance with predefined settings of said associated bypass switch in order to ensure the sequence of switching.

68. The method as claimed in claim 64, wherein said step of controlling the voltage across said transformer is performed mechanically by way of a safety key interlock of said associated bypass switch in order to ensure the sequence of switching.

69. The method as claimed in claim 66, wherein the step of opening said first switch is initiated by removal of a safety key that rotates a shaft connected to said first switch in order to open said first switch and thereby disconnect said power supply to said variable voltage control circuit.

70. The method as claimed in claim 66, wherein when said transformer has been disconnected from said power supply, but is required to be reconnected, the method performs the following steps:
closing said third switch device in order to reapply the voltage to said transformer based voltage optimization device;
opening said second switch device; and
closing said first switch device after said second switch device is opened.
